(19) United States
(12) Patent Application Publication
(10) Pub. No.: US 2017/0178535 A1
(43) Pub. Date: Jun. 22, 2017

(54) Counter Band

(71) Applicant: Luciano J. Vignola, Mt. Juliet, TN (US)

(72) Inventor: Luciano J. Vignola, Mt. Juliet, TN (US)

(21) Appl. No.: 14/974,533

(22) Filed: Dec. 18, 2015

(51) Int. Cl. G09B 19/00; G06F 3/023; G06F 1/16; G06F 3/0482; G06F 3/0485

(52) U.S. Cl. CPC G09B 19/0092; G06F 3/0482; G06F 3/0485; G06F 1/1635; G06F 3/023

(57) ABSTRACT

This invention relates to a device that counts the amount of liquid that a user consumes on a daily bases, and, more specifically, for keeping track of the liquid consumption of individuals who engage themselves in strict exercise regimens, such as athletes, sportspersons, gym goers, etc., and those who are attempting to reduce their body weight by dieting.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention relates to the field of devices that track an individual's consumption of liquids. The invention particularly relates to a device that allows an individual to track the amount of liquid consumed from a liquid container.

(2) Background of the Invention

Health is a top priority for most people nowadays. In order to keep healthy, people around the world take up different types of exercise regimens that suit them. It is highly recommended by health professionals that a person consume approximately eight 8 ounce glasses of water daily, i.e. approximately 64 ounces of water daily, to maintain proper body functions. Proper water consumption is particularly emphasized for individuals who engage in strict exercise regimens and those who are attempting to reduce their body weight by dieting. It is important that they remain hydrated all the times, as the body loses lots of fluids through urine or sweat.

A suggested formula for a daily water intake after evaluating users physical condition is ½ ounce per pound of body weight when an individual is inactive, and ⅔ ounce per pound when an individual is engaged in athletic activity. It has been suggested that, before exercise, water be ingested. The water intake should be at regular intervals throughout waking hours.

Keeping track of the amount of water consumed in a day requires some type of recording procedure, since it is easy for a person to forget how many glasses of water have been consumed during any given day. However, the recording procedure should be simple to use, and the recording means needs to be incorporated onto the outer surface of a liquid container so that the volume can be recorded by the user. The device should also be relatively small, so that it does not interfere with the use or change the appearance of the liquid container. Also, the device should be designed so that the recorded amount cannot be accidentally altered during the 24 hour period under normal use conditions.

A number of different types of devices are available for tracking consumption of liquid. For example, U.S. patent application Ser. No. 11/58,557 to Lisa, U.S. patent application Ser. No. 13/856,744 to Jeffery, U.S. Pat. No. 6,747,918 to Biscoff et al., U.S. patent application Ser. No. 13/918,1 to Carlos, U.S. Pat. No. 8,378,830 to Dan, U.S. Pat. No. 6,747,918 to Hight et al., U.S. Pat. No. 851,997 to Michael, U.S. Pat. No. 56,778 to Nordberg et al., and U.S. Pat. No. 6,523,688 to Herman all disclose these devices.

A need exists for a device to enable an individual to tally the consumption of water in measurable amounts throughout a given period, e.g. a 24 hr. period. It is an objective of the present invention to provide a device that enables storing the measurement of liquids along with a resettable indicator to tally the number of refills of the vessel, and, therefore, the consumption of liquid over a designated period.

### SUMMARY OF THE INVENTION

In the view of the foregoing disadvantages inherent in the known types of devices for counting liquid consumption now present in the prior art, the present invention provides an improved liquid consumption counting device. As such, the general purpose of the present invention, which will be described subsequently in greater detail, is to provide a new and improved liquid consumption counting device that has all of the advantages of the prior art and none of the disadvantages.

An objective of the invention is to provide a device that counts the amount of liquid that a user consumes on a daily bases.

It is another objective of the present invention to provide a device that keeps track of liquid consumption for a specific workout regimen.

It is another objective of the present invention to provide a device that counts liquid consumption in order to increase consumption of water, Gatorade, etc.

It is another objective of the present invention to provide a device that enables a user to measure liquid consumption in any form of measurement e.g. gallon, liters, quarts, cups, or the like.

It is another objective of the present invention to provide a device that counts each time a liquid container is refilled.

It is another objective of the present invention to provide a device that reminds a user that a set goal amount has been achieved.

It is another objective of the present invention to provide a device that is waterproof.

It is another objective of the present invention to provide a device that is easy to assemble or dissemble.

It is yet another objective of the present invention to provide a device that is powered by solar energy.

It is yet another objective of the present invention to provide a device that is shockproof and able to withstand all weather and conditions.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure. For a better understanding of the invention, its operating advantages and the specific objectives attained by its uses, reference should be had to the accompanying drawings and descriptive matter, in which there are illustrated preferred embodiments of the invention.

### BRIEF DESCRIPTION OF THE DRAWINGS

The invention will be better understood, and objectives other than those set forth above will become apparent, when consideration is given to the following detailed description thereof. Such description makes reference to the annexed drawings, wherein:

FIG. 1 shows the (front) view of the counter band on bottle.

FIG. 2 shows the (front) view of the liquid consumption counting device.

FIG. 3 shows the (front) view of the premium liquid consumption-counting device (Also known as Infinite Counter Band), or counter band.

FIG. 4 shows the (rear) view of the premium liquid consumption-counting device.

FIG. 5 shows the (back) view of the premium liquid consumption-counting device.

### DETAILED DESCRIPTION OF THE INVENTION

In the following detailed description, reference is made to the accompanying drawings, which form a part hereof, and in which is shown, by way of illustration, specific embodiments in which the invention may be practiced. These embodiments are described in sufficient detail to enable those skilled in the art to practice the invention, and it is to be understood that the embodiments may be combined, or that other embodiments may be utilized, and that structural, logical, and electrical changes may be made without departing from the spirit and scope of the present invention. The following detailed description is, therefore, not to be taken in a limiting sense, and the scope of the present invention is defined by the appended claims and their equivalents.

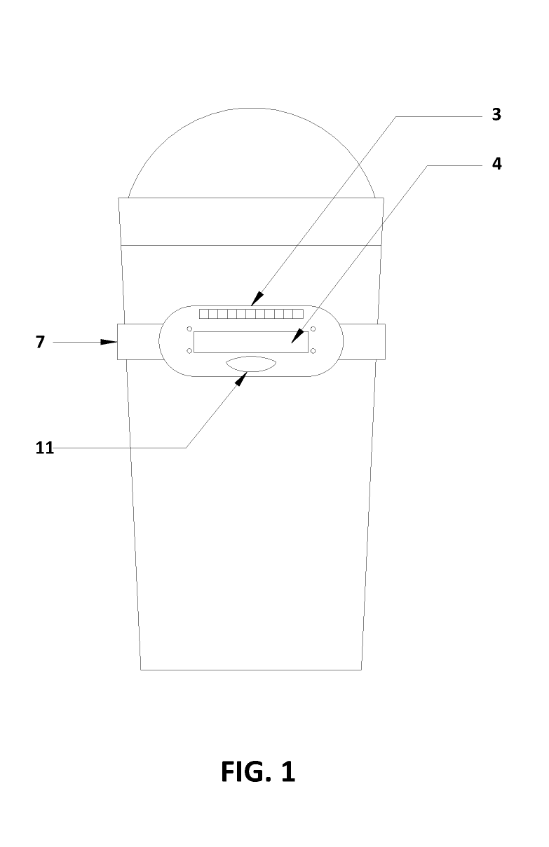

Referring now to the drawings, wherein like reference characters designate identical, or corresponding parts throughout the figures, and in particular FIG. 1 shows an embodiments of the rechargeable washing machine in accordance with the present invention.

FIG. 1 shows the (front) view of the counter band on bottle including, the water bottle or liquid container 7, solar panel 3, display screen or display 4 and light button 11.

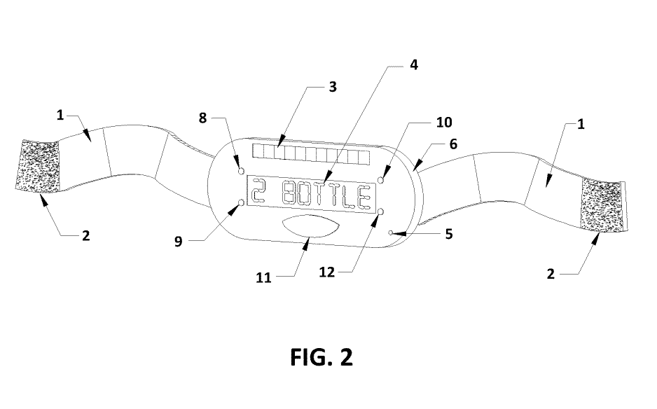

FIG. 2 shows the (front) view of the liquid consumption counting device including, the elastic rubber band 1, Velcro 2, solar panel 3, display screen 4, beep speaker 5, rubber casings 6, count button 8, menu button 9, select button 10, light button 11, down button 12.

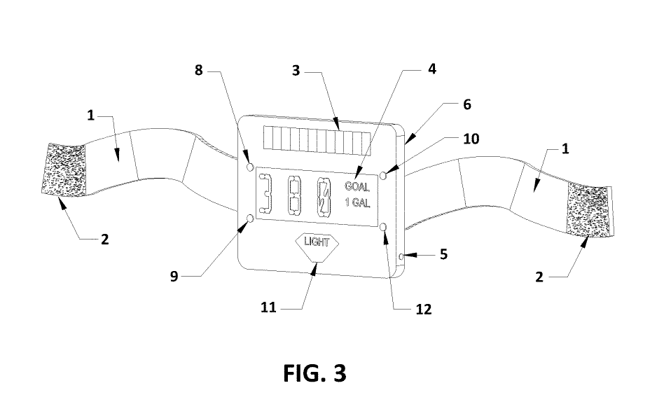

FIG. 3 shows the (front) view of the premium liquid consumption-counting device including, the elastic rubber band 1, Velcro 2, solar panel 3, display screen 4, beep speaker 5, rubber casings 6, count button 8, menu button 9, select button 10, light button 11, down button 12.

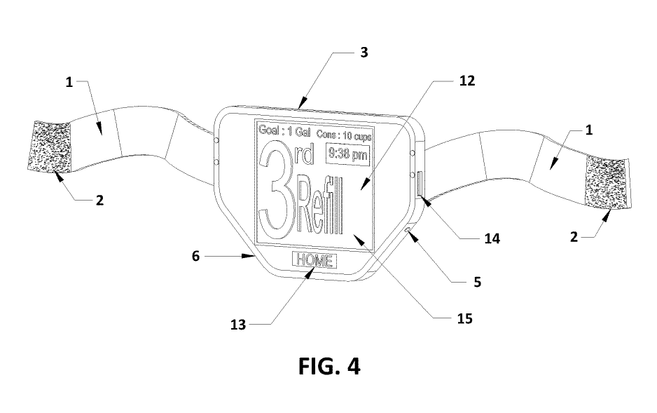

FIG. 4 shows the (rear) view of the premium liquid consumption-counting device including, the elastic rubber band 1, Velcro 2, solar panel 3, beep speaker 5, rubber casings 6, down button 12, LED screen 13, home button 14, USB 15.

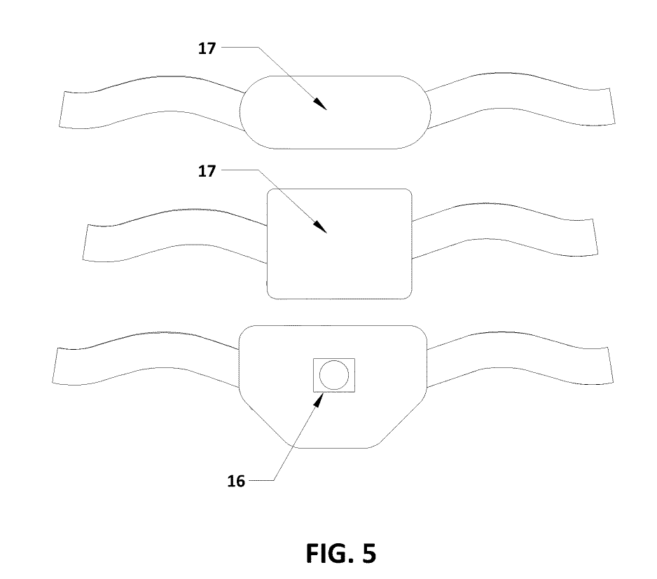

FIG. 5 shows the (back) view of the premium liquid consumption-counting device including sensor 16 and rubber on the band 17.

FIG. 1 illustrates the device wrapped around the liquid container, e.g. a water bottle 7, a mug, a cup, etc., using the elastic rubber band 1. The device is provided with solar band 3 and display screen 4. The figure also shows the liquid consumption counting device, or counter band, that wraps around a water bottle 7 and serves as a liquid container with various colored rubber casings 6, e.g. red, blue, green, purple, etc.

In a preferred embodiment of the invention if the user selects a goal amount, then he must enter the amount of liquid, i.e. water, Gatorade, etc., that the liquid container can hold in liters, gallons, quarts, etc., into the device that is attached to the liquid container. The device then calculates the amount of liquid intake it will take to get to the goal amount set by user. From there the Counter Band subtracts the amount (capacity) that the liquid container holds from the goal amount each time the count button is pressed until the goal is reached. The device beeps using a beep speaker 5, and resets once the goal amount is reached.

FIG. 2 and FIG. 3, illustrates a liquid consumption counting device having an elastic rubber band 1 attached to an LCD screen 4 on its left and right side, forming a strap. Velcro 2 is attached to the proximal end of elastic rubber band 1 on each side. The elastic rubber band 1 has rubber 17 at its rear or back portion. Furthermore, a solar panel 3 is provided on top portion of the device for powering the device. The solar panel 3 enables the device to run on solar energy, and, thereby, no frequent change of batteries is required. This enables a user to literally count the intake of liquid round the clock, or 24/7. A Beep speaker 5 is provided to alert the user when a certain set goal amount of liquid consumption is reached.

The LCD screen 4 is provided for display. The LCD screen is connected to a durable elastic rubber band 1 that allows the user to easily assemble and dissemble the device. A control panel is provided that has a number of buttons provided to perform different functions. The Count button 8 is provided to be pressed each time the liquid containing container is refilled. The Menu button 9 provides the options to access a Stopwatch, Count Down Timer, Goal Reset, set a Goal amount, and different measurement units for counting the amount of liquid consumed, e.g. Gallon, quarts, cups, liters, etc. The Select button 10 helps a user select the appropriate option out of the available options in the menu, such as setting a goal amount, setting a unit for measuring amount of liquid intake, or the like. The Light button 11 illuminates the display screen in the dark. The user needs to tap the light button 11 once for 4 seconds of light, and twice for consistent light. After 1 minute of inactivity, it shuts down. The down button 12 is the located on the bottom right of the LCD screen. The down button 12 is pressed by a user to scroll through the provided menu. The device is provided with a processing means unit that has the ability to process all of the information, e.g. the goal amount, calculation of amount of liquid intake, the different units of measuring the liquid intake, etc., and is connected to each functional part of the device.

FIG. 4 shows another embodiment of the device, i.e. the Premium counter band (Known as Infinite Counter Band) provided with a solar panel 3, an LED touch screen 13, a Home button 14 to reset the counter, and a USB port 15. The device shown in this figure also has Bluetooth and Wi-Fi connectivity, which enables it to connect to a smartphone. The premium device also provides date and time, a calendar for fitness appointments, and a GPS Tracker called “Find My Counter Band.” The GPS tracker enables the user to track the liquid consumption counting device, when it is misplaced or lost. The user can locate the counting device by accessing a mobile application “counter band app”. The GPS tracker connects remotely to app running on the smartphone.

FIG. 5 shows a sensor 16 that counts the number of times the liquid container is refilled. The sensor 16 is placed on the rear side of the display screen 14. The figure also shows rubber 17 on the rear portion.

The elastic rubber band 1 is durable and stretchable. The device is waterproof and shockproof. Thus, the device of is suited to function in any environment.

This device (Both Base Model Counter Band and Premium “Infinite Counter Band”) also includes a Pre-set/Countdown timer. A user can set a 30 second, 1 min, 3 min, 5 min, 10 min, 15 min, 20 min, 25 min, 30 min, 45 min, or 60 min count down. Just like the stopwatch, the user can turn on the countdown function and then go to any other screen while the timer continues its countdown. The device will have a distinguished rhythmic beep to alert the user that the countdown has ended. The user will know the difference between countdown beep and completion of liquid goal beep.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages that may be provided by the present invention have been described above with regard to specific embodiments. These benefits and advantages, and any elements or limitations that may cause them to occur or to become more pronounced, are not to be construed as critical, required, or essential features of any or all of the embodiments.

While the present invention has been described with reference to particular embodiments, it should be understood that the embodiments are illustrative, and that the scope of the invention is not limited to these embodiments. Many variations, modifications, additions, and improvements to the embodiments described above are possible. It is contemplated that these variations, modifications, additions, and improvements fall within the scope of the invention.

I claim:

1. A liquid consumption counting device, comprising:
an elastic rubber band;
a sensor;
a processing means unit;
a display screen;
a control panel;
a plurality of control buttons;
a Velcro attached to the proximal end of said elastic rubber band; and
a solar panel.

2. The liquid consumption counting device according to claim 1, wherein said elastic rubber band wraps around an outer surface of a liquid container.

3. The liquid consumption counting device according to claim 1, wherein said elastic rubber band wraps around an outer surface of a liquid container and is closed by said Velcro.

4. The liquid consumption device according to claim 1, wherein said sensor automatically counts liquid consumption.

5. The liquid consumption device according to claim 1, wherein said sensor is connected with said processing means unit.

6. The liquid consumption counting device according to claim 1, wherein said processing means unit processes all of the information.

7. The liquid consumption counting device according to claim 1, wherein said display screen is an LCD screen.

8. The liquid consumption counting device according to claim 1, wherein said control panel is comprised of a plurality of control buttons.

9. The liquid consumption counting device according to claim 1, wherein said plurality of control buttons includes Down, select, menu, light, and count.

10. The liquid consumption counting device according to claim 9, wherein said Down button is pressed by a user to scroll through the provided menu.

11. The liquid consumption counting device according to claim 9, wherein said select button enables said user to select a function from provided menu.

12. The liquid consumption counting device according to claim 9, wherein said menu button provides a stopwatch, goal amount, measurements of container, count down timer and goal reset.

13. The liquid consumption counting device according to claim 9, wherein said light button illuminates said display screen.

14. The liquid consumption counting device according to claim 9, wherein said count button is pressed by said user to count every time said liquid container is filled.

15. The liquid consumption counting device according to claim 1, wherein said device is powered by solar energy provided by said solar panel.

16. The liquid consumption counting device according to claim 1 further comprises:
a USB port;
Bluetooth and Wi-Fi connectivity; and,
a GPS tracker.

17. The liquid consumption counting device according to claim 16, wherein said USB port is provided for connecting to a Laptop.

18. The liquid consumption counting device according to claim 16, wherein said Bluetooth or Wi-Fi connectivity is provided to remotely connect to a smartphone.

19. The liquid consumption counting device according to claim 16, wherein the liquid consumption device is waterproof.

20. The liquid consumption counting device according to claim 16, wherein the liquid consumption device is shock proof

21. The liquid consumption counting device according to claim 16, wherein the liquid consumption device is Weather Proof.

22. The liquid consumption counting device according to claim 16, wherein said GPS tracker provides exact location of the liquid consumption counting device.

23. The liquid consumption counting device according to claim 16, wherein said GPS tracker is remotely connected to a mobile application running the user's smartphone.
